(19) United States
(12) Patent Application Publication
(10) Pub. No.: US 2014/0168279 A1
(43) Pub. Date: Jun. 19, 2014

(54) DIMMING A DISPLAY DEVICE

(71) Applicant: HEWLETT-PACKARD DEVELOPMENT COMPANY, L.P., Fort Collins, CO (US)

(72) Inventor: Yang Huang, Shanghai (CN)

(73) Assignee: HEWLETT-PACKARD DEVELOPMENT COMPANY, L.P., Fort Collins, CO (US)

(21) Appl. No.: 13/813,649

(22) PCT Filed: Dec. 14, 2012
(86) PCT No.: PCT/CN2012/086691

§ 371 Date: Jan. 31, 2013

(51) Int. Cl. G06F 1/32; G09G 3/34

(52) U.S. Cl. CPC G06F 1/3203; G09G 3/3406
USPC 345/690

(57) ABSTRACT

A display device is dimmed after a threshold time of in activity has elapsed. The threshold time may be determined from a user's content viewing behavior and content source. The threshold time is dynamically adjusted based on changes in at least one of the user's viewing behavior and the content source.

### BACKGROUND

A computing device may include a display device to interface with a user. For example, the display device may present information (e.g., output information) to the user. A display device may consume a significant amount of power available to the computing device.

### BRIEF DESCRIPTION OF THE DRAWINGS

The following detailed description references the drawings, wherein:

FIG. 1 is a block diagram of a computing device including a controller for dimming a display device, according to one example;

FIG. 2 is a block diagram of a computing device including a controller for dimming a display device, according to one example;

FIG. 3 is a flowchart of a method for dimming a display device, according to one example;

FIG. 4 is a flowchart of a method for dimming a display device, according to one example; and

FIG. 5 is a block diagram of a computing device including a non-transitory machine-readable storage medium encoded with instructions for dimming a display device, according to one example.

### DETAILED DESCRIPTION

Various aspects of the present disclosure are directed to dimming a display device. More precisely, various aspects of the present disclosure are directed to dynamically adjusting a threshold time to dim the display device based on a combination of the user's viewing behavior (e.g., reading profile) and a content source.

With the rapid development of mobile devices (e.g., tablets and smartphones) and applications that run on the mobile devices, users spend much more time reading content from their mobile devices. For example, a mobile device may operate as an e-reader (or enabled with an e-reader) for reading digital e-books and periodicals. Depending on the content being read and the display size of the display device, the time needed to finish reading the displayed content varies. In addition, the display device may represent a significant amount of power consumed by the computing device.

To optimize power consumption, a device may shut off the screen (or dim the screen) after a period of time when no user intervention occurs. However, the user may still be reading the content when the shut off time occurs. Thus, the user may need to interact with the device (e.g., tap on the screen, provide an input, or turn on the screen again) to keep the screen on from time to time. Certain applications running on the computing device may optionally allow the user to disable the auto-screen-off feature, thereby keeping the screen on as long as the application is running. However, this may not optimize power consumption. For example, the user may inadvertently leave the application running without shutting down the screen, thereby draining the battery power.

Accordingly, examples disclosed herein provide a solution for dynamically (e.g., in real-time) adjusting a threshold time before the display device dims based on the user's viewing behavior (e.g., the user's reading profile) and context of the displayed content (e.g., content source and content type). In addition, the threshold time may be dynamically adjusted based on a current battery level of the computing device.

In one example, a computing device includes a display device to display content, a. sensor to detect user input, and a controller. The controller is to determine a user's viewing behavior from the user input and to determine a source of the content from multiple content sources. The controller is to dim the display device after a threshold time of inactivity has elapsed on the computing device, where the threshold time is determined from the user's viewing behavior and the content source. The controller is further to dynamically adjust the threshold time before the display device dims based on changes in at least one of the user's viewing behavior and the content source.

In another example, a method for dimming a display device tray include displaying content on a display device and determining an initial threshold time to dim the display device. The initial threshold time may be determined from a user's content viewing behavior and the content source. The method may also include dimming the display device after the initial threshold time of inactivity has elapsed and dynamically adjusting the initial threshold time based on changes in at least one of the user's content viewing behavior and the content source.

In another example, a non-transitory computer-readable medium may include instructions that, when executed by a processor in a computing device, cause the processor to determine a user's content viewing behavior from the user's input and to determine a source of the content from multiple content sources. The instructions are executable to dim a display device after a threshold time of inactivity has elapsed on the computing device, where the threshold time is determined from the user's viewing behavior and the content source. The instructions are further executable to dynamically adjust the threshold time before the display device dims based on changes in at least one of the user's viewing behavior and the content source.

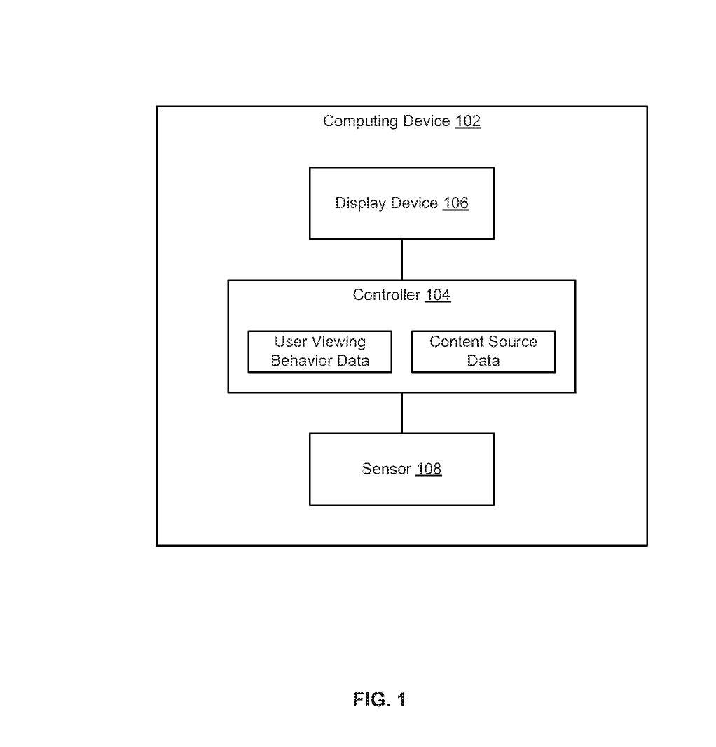

FIG. 1 depicts a block diagram of a computing device including a controller for dimming a display device, according to one example. Computing device 102 may include a display device 106, a controller 104, and a sensor 108. Computing device 102 may be a mobile device, a media player, a tablet computer, a laptop computer, a smartphone, or a personal digital assistant (PDA), for example. Controller 104 may be communicatively coupled to the display device 106 and to the sensor 108.

Display device 106 may be a light-emitting diode (LED), a plasma display, a liquid crystal display (LCD), an organic light-emitting diode display (OLED), or another display technology, for example. The display device 106 may be a 2-dimensional display or a 3-dimensional display. Moreover, the display device 106 may be a touch-sensitive display device. In one example, the display device 106 is to display content to a user. In other examples, the display device 106 may operate as an input device/source (e.g., in addition to or as an alternate to a keyboard). In this example, a virtual keyboard image may be displayed on the display device and alphanumeric input may be provided using the virtual keyboard.

Sensor 108 may be configured to detect user input to the computing device 102. For example, sensor 108 may detect user input via a stylus, a hand gesture, a keypad, a pointing device, a clicking device, a mouse, and other input mechanisms. In certain examples, the sensor 108 may detect a user input corresponding to the user's desire to continue viewing content on the display device 106. Such desires may be expressed by the user scrolling up or down a content window, keypad input, opening/closing one or more applications, or a touch input. It should be noted that sensor 108 may include a group of sensors for detecting the user input.

Controller 104 may determine the user's content viewing behavior from the user input, For example, the user's viewing behavior may include the user's reading speed (e.g., reading profile) measured from the user's interaction with the computing device 102 and/or the display device 106. The user's viewing behavior may be determined from a frequency of the user's interaction with the computing device 102. To illustrate, a user may tap on the display device 106 (e.g., a touch-sensitive display) to prevent the display device 106 from dimming or shutting off. As another example, the user may scroll up/down to view more content. Accordingly, the user's interaction with the computing device 102 may indicate that the user wishes to continue viewing the content. Thus, such user interactions may include a touch input, scrolling up or down the content window, typing text, opening applications, and closing applications, for example.

In certain examples, controller 104 is able to distinguish between when the user intentionally wishes to keep the display device 106 on for a longer period of time to continue reading content and when the user is interrupted from reading the content. To illustrate, when the user taps the touch screen when reading an email, the user's intention may likely be to keep the screen on for a longer period of time because the user needs more time to consume the content. In this case, controller 104 will automatically adjust the threshold time until the next dim. However, when the user is reading the email and switches to a short message service (SMS) application to send a text message and then returns to the email, controller 104 may not adjust the threshold time.

In certain examples, the user's reading speed includes the user's average reading speed, the user's reading speed associated with content from a particular source, the user's reading speed associated with a particular content type, and the user's historical reading speed as determined by the controller 104 over a period of time.

Controller 104 may further determine a source of the content from a plurality of content sources. For example, the plurality of content sources may include an email client, an e-book reader, a web browser, a social networking application, and other applications that provide content to the user.

Accordingly, controller 104 may extract user viewing behavior data and content source data for dimming the display deice 106. Thus, controller 104 may dim the display device 106 after a threshold time of inactivity has elapsed on the display device 106 and dynamically adjust the threshold time (e.g., threshold time before a next dim), based on changes in the user's viewing behavior and the content source. Dimming the display device 106 may include adjusting an intensity of the display device 106 or shutting off the display device 106 to conserve power.

In one example, the controller 104 may set an initial threshold time to dim the display device 106. The initial threshold time may be based on at least one of the user's historical viewing behavior (e.g., average reading speed) and the content source (e.g., application reading speed). Accordingly, when the initial threshold time has elapsed, the display device 106 may dim (or begin to dim). The user may wish to continue reading and may provide an input (e.g. tap the display screen). Based on the user input, the controller 104 determines that the user requires more time to view the content and adjusts the initial threshold time accordingly. Thus, the initial threshold time for a next threshold time to dim the display device 106 is dynamically adjusted. The following example implementation illustrates a scenario where the threshold time to dim the display device 106 is dynamically adjusted.

A user opens an email client and starts reading an email. The user's general reading, speed is determined to be 10.3 seconds (e.g., based on data compiled over time). The average reading time of the user for the email client is 17 seconds (e.g., based on historical data). The controller 104 therefore sets the current device dim time to 17 seconds (i.e., the greater of the user's average reading time and the user's application/content source reading time). Because the user is reading a report that contains numbers and tables, the user needs more time to consume the content. The display device 106 gets dim after 17 seconds and is about to shut down. The user touches the display device 106 in order to keep reading. Controller 104 therefore determines that the user needs more time and dynamically adjusts the application average reading time to a longer time of 20 seconds. Accordingly, the time before the next screen dim time will be adjusted to 20 seconds, Controller 104 also updates the application average reading time based on the increase. Accordingly, power consumption of the computing device 102 is reduced and user experience is improved.

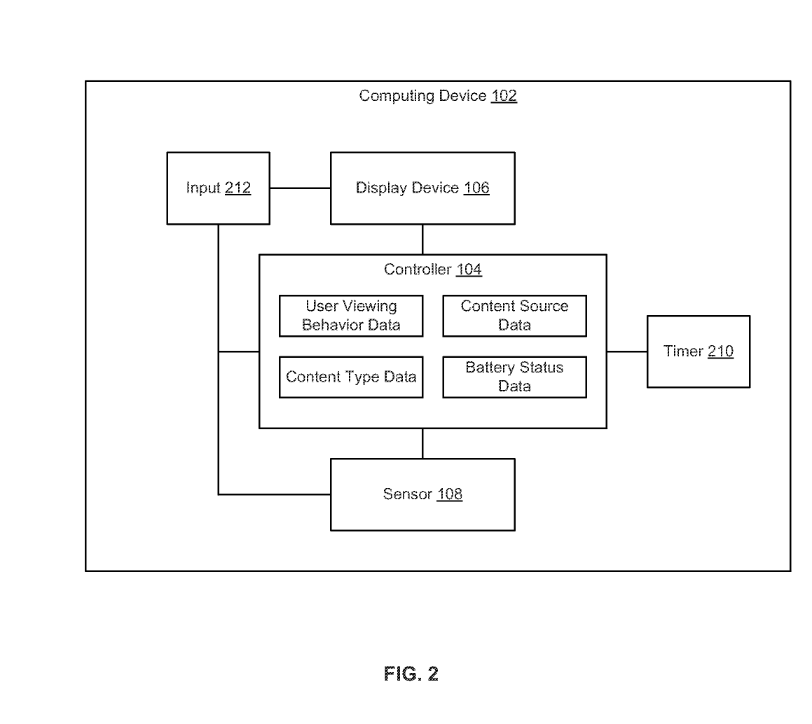

FIG. 2 is a block diagram of a computing device including a controller for dimming a display device, according to one example. In the example of FIG. 2, computing device 102 includes display device 106, controller 104, sensor 108, a timer 210, and an input source 212.

Timer 210 may be configured to track the threshold time to dim the display device 106. When the timer 210 indicates that the threshold time has expired, the controller 104 may dim for begin to dim) the display device 106. Controller 104 may dynamically reset the tinier 210 to increase or decrease a threshold time till the next dim, based on changes in the user's viewing behavior and the content source.

Input source 212 may be a part of or separate from the display device 106. In certain examples, the display device 106 may be a touch sensitive screen, where input is entered on the display device 106 (e.g., via stylus pen). In other examples, the input source is separate from the display device, where input is entered via a keypad, a mouse, or other external input devices.

In the example of FIG. 2, controller 104 may also determine a type of content from a plurality of content types. Thus, the threshold time to dim the display device may be dynamically adjusted based on changes in the content type. The content types may be images, text, or a combination thereof. In other examples, controller 104 may determine a battery status of the computing device 102. In such examples, the initial threshold time to dim the display device 106 may be dynamically adjusted based on a current status of the battery (e.g., current battery level) such that power consumption of the computing device 102 is optimized. To illustrate, when the battery power is fully charged or above a certain, controller 104 may increase the threshold dim time by 5 seconds when the user requires more time to read, and when the battery is below a certain level controller 104 may increase the threshold dim time by 2 seconds. Thus, in the example of FIG. 2, controller 104 may dynamically reset the timer 210 to increase or decrease a threshold time till the next dim, based on changes in the user's viewing behavior, content source, content type, battery status, or any combination thereof.

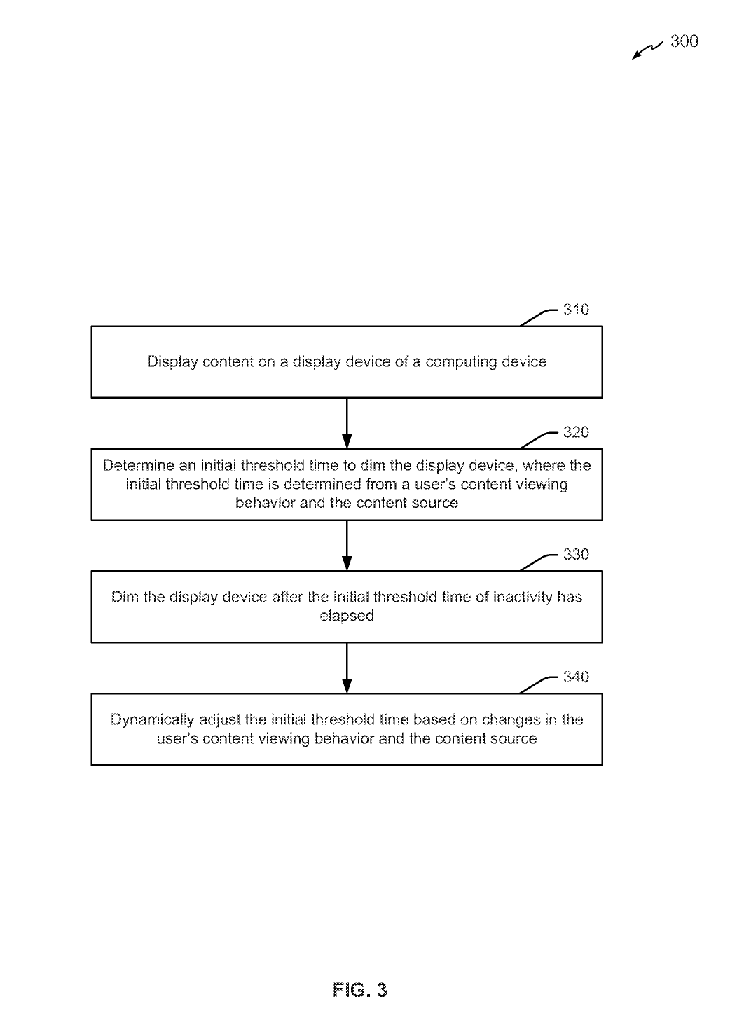

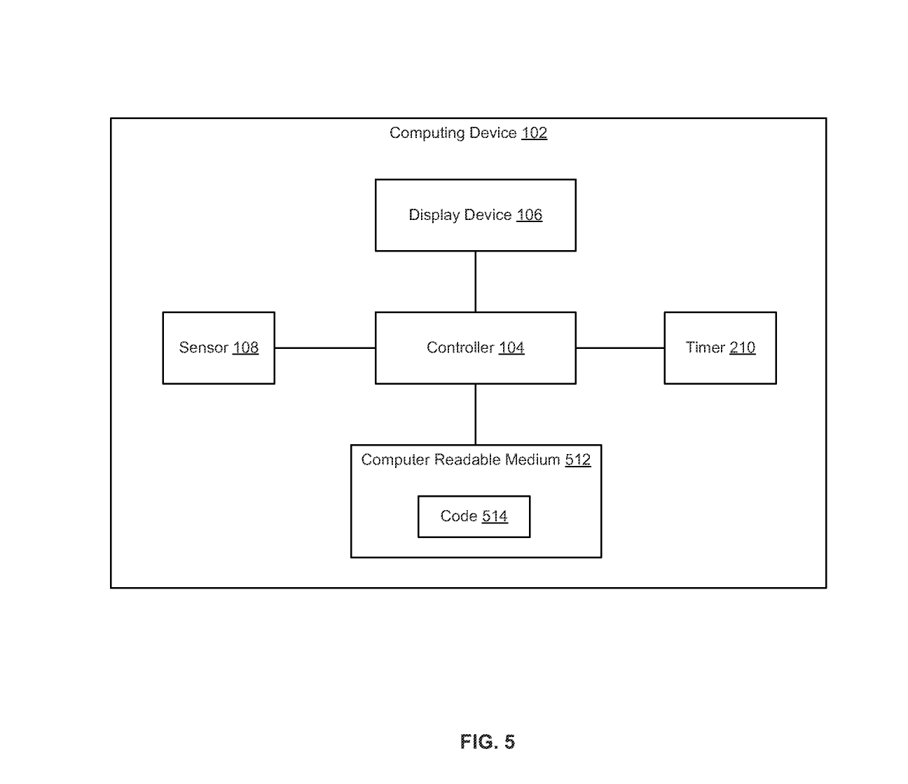

FIG. 3 is a flowchart of a method 300 for dimming a display device, according to one example. Although execution of method 300 is described below with reference to the components of computing device 102, other suitable components for execution of method 300 will be apparent to those of skill in the art. Additionally, the components for executing the method 300 may be spread among multiple devices. Method 300 may be implemented in the form of executable instructions stored on a machine-readable storage medium, such as non-transitory machine-readable storage medium 512 of FIG. 5, and/or in the form of electronic circuitry.

Method 300 includes displaying content on a display device of a computing device, at 310. For example, display device 106 may display a plurality of content types from multiple content sources. The method 300 further includes determining an initial threshold time to dim the display device, at 320. In certain examples, the initial threshold time is determined from a user's content viewing behavior and the content source. In other examples, the initial threshold time is determined based on the battery status of the computing device.

The method 300 further includes dimming the display device after the initial threshold time of inactivity has elapsed, at 330. For example, timer 210 may track the threshold time and upon expiration of the threshold time, controller 104 dims the display device 106. Dimming the display device 106 includes reducing an intensity of the display device 106 or shutting off the display device 106.

The method 300 includes dynamically adjusting the initial threshold time based on changes in the user's content viewing behavior and the content source, at 340. For example, controller 104 may dynamically adjust a threshold time until the next dim based on the user's viewing profile and based on the content source. Accordingly, the threshold time to dim the display device 106 may be updated in real-time (e.g., as the user is viewing content on the display device 106). In certain examples, the threshold time may be adjusted/updated by measuring the time between a first input arid a second input from the user (i.e., two user interventions) while viewing content from a particular content source (e.g., an email client), and dynamically adjusting the threshold time based on the measurement. In other examples, the threshold time may be adjusted/updated by calculating a time difference between when a user input is received and the initial threshold time to dim the display device 106. The threshold time may be dynamically adjusted based on the calculation.

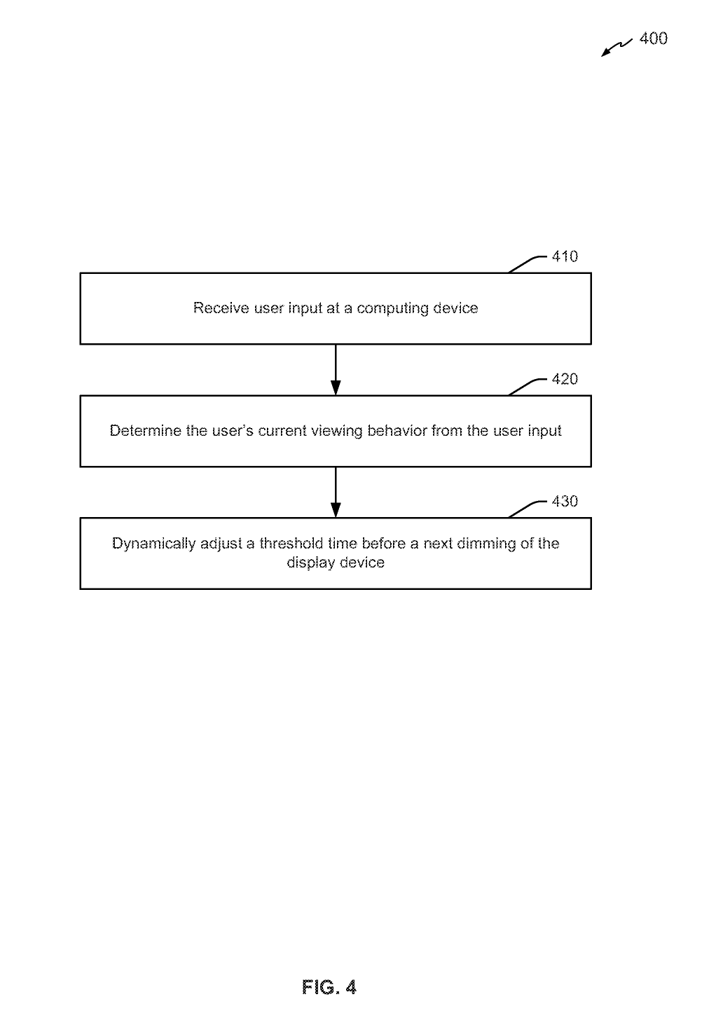

FIG. 4 is a flowchart of a method 400 for dimming a display device, according to one example. Although execution of method 400 is described below with reference to the components of computing device 102, other suitable components for execution of method 400 will be apparent to those of skill in the art. Additionally, the components for executing the method 400 may be spread among multiple devices. Method 400 may be implemented in the form of executable instructions stored on a machine-readable storage medium, such as non-transitory machine-readable storage medium 512 of FIG. 5, and/or in the form of electronic circuitry.

Method 400 includes receiving user input at a computing device, at 410. For example, the user input may be via a hand a gesture, a pointing device, a clicking device, a mouse, a keypad, or any combination thereof. Method 400 also includes determining the user's current viewing behavior from the user input, at 420. For example, controller 104 may determine the user needs more or less time to view a particular content based on the user's interaction (i.e., input) with the display device 106.

Method 400 further includes dynamically adjusting a threshold time before a next dimming of the display device. For example, based on the user's viewing behavior for the particular content, controller 104 may dynamically update the threshold time to dim the display device 106.

FIG. 5 is a block diagram of a computing device including a non-transitory machine-readable storage medium encoded with instructions for dimming a display device, according to one example. Computing device 102 includes machine-readable storage medium 512. Machine-readable storage medium 512 includes code 514 that, when executed by controller 104, causes controller 104 to determine a user's content viewing behavior from the user's input.

The code 514 can also cause the controller 104 to determine a source of the content from multiple content sources and to dim the display device 106 after a threshold time of inactivity has elapsed on the computing device 102. The threshold time is determined from the user's viewing behavior and the content source. Code 514, when executed, can cause the controller 104 to dynamically adjust the threshold time before the display device 106 dims based on changes in the user's viewing behavior and the content source.

The techniques described above may be embodied in a computer-readable medium for configuring a computing device to execute the method. The computer-readable media may include, for example and without limitation, any number of the following non-transitive mediums: magnetic storage media including disk and tape storage media; optical storage media such as compact disk media (e.g., CD-ROM, CD-R, etc.) and digital video disk storage media; holographic memory, nonvolatile memory storage media including semiconductor-based memory units such as FLASH memory, EEPROM, EPROM, ROM; ferromagnetic digital memories; volatile storage media including registers, buffers or caches, main memory RAM, etc; and the Internet, just to name a few. Other new and various types of computer-readable media may be used to store the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present disclosure. However, it will be understood by those skilled in the art that the present disclosure may be practiced without these details. While the disclosure has been described with respect to a limited number of examples, those skilled in the art will appreciate numerous modifications and variations therefrom. It is intended that the appended claims cover such modifications and variations as fall within the true spirit and scope of the disclosure.

What is claimed is:

1. A computing device comprising:
a display device to display content;
a sensor to detect user input; and
a controller to:
determine a user's content viewing behavior from the user input;
determine a source of the content from multiple content sources;
dim the display device after a threshold time of inactivity has elapsed on the computing device, wherein the threshold time is determined from the user's viewing behavior and the content source; and
dynamically adjust the threshold time before the display device dims based on changes in at least one of the user's viewing behavior and the content source.

2. The device of claim 1, the controller further to:
determine a type of content from a plurality of content types, wherein the content type comprises at least one of image and text; and
dim the display device after the threshold time of inactivity has elapsed, wherein the threshold time is determined from the content type; and
dynamically adjust the threshold time before the display device dims based on changes in the content type.

3. The device of claim 1, further comprising a timer to track the threshold time.

4. The device of claim 1, the controller further to dynamically adjust the threshold time before the display device dims based on a battery status of the computing device.

5. The device of claim 1, wherein the content source comprises at least one of an email client, an e-book reader, a web browser, a social networking application, and other applications that provide content to the user.

6. The device of claim 1, wherein the user's viewing behavior comprises the user's reading speed measured from the user's interaction. with the computing device, and wherein the user's interaction comprises at least one of touching the display device, scrolling up or down a content window, typing text, opening applications, and closing applications.

7. The device of claim 6, wherein the user's reading speed comprises at least one of the user's average reading speed, the user' reading speed associated with content from a particular source, the user's reading speed associated with a particular content type, and the user's historical reading speed.

8. The device of claim 1, wherein dimming the display device comprises at least one of adjusting an intensity of the display device and shutting off the display device.

9. The device of claim 1, wherein the display device comprises an input source and wherein the input source comprises at least one of a touch-sensitive screen, a keyboard, and other input mechanisms.

10. The device of claim 1, wherein the user input comprises at least one of a stylus, a hand gesture, a pointing device, a clicking device, a mouse, and a keypad.

11. A method for dimming a display device comprising:
displaying content on a display device of a computing device;
determining an initial threshold time to dim the display device, wherein the initial threshold time is determined from a user's content viewing behavior and the content source;
dimming the display device after the initial threshold time of inactivity has elapsed; and
dynamically adjusting the initial threshold time based on changes in at least one of the user's content viewing behavior and the content source.

12. The method of claim 11, further comprising:
receiving user input at the computing device; and
determining the user's current content viewing behavior from the user input; and
dynamically adjusting the initial threshold time before a next dimming of the display device.

13. The method of claim 12, wherein the user input includes at least one of touching a touch-sensitive display device, scrolling up or down a content window, typing text, opening applications, and closing applications.

14. A non-transitory computer-readable medium comprising instructions that, when executed by a processor in a computing device, cause the processor to:
determine a user's content viewing behavior from the user's input;
determine a source of the content from multiple content sources;
dim a display device after a threshold time of inactivity has elapsed on the computing device, wherein the threshold time is determined from the user's viewing behavior and the content source; and
dynamically adjust the threshold time before the display device dims based on changes in at least one of the user's viewing behavior and the content source.

15. The non-transitory computer-readable medium of claim 14, wherein the instructions are further executable by the processor to:
determine a type of content from a plurality of content types; and
dim the display device after the threshold time of inactivity has elapsed, wherein the threshold time is determined from the content type; and
dynamically adjust the threshold time before the display device dims based on changes in the content type,
wherein the content source comprises at least one of an email client, an e-book reader, a web browser, a social networking application, and other applications that provide content to the user,
wherein the user's viewing behavior comprises at least one of the user's average reading speed, the user' reading speed for content from a particular source, the
user's reading speed for a particular content type, and the user's historical reading speed, and
wherein the content type comprises at least one of image and text.
